(19) United States
(12) Patent Application Publication
(10) Pub. No.: US 2010/0258390 A1
(43) Pub. Date: Oct. 14, 2010

(54) HYBRID ELECTROMECHANICAL ACTUATOR BRAKE FOR WIND TURBINES

(76) Inventor: Michael O. Culbertson, Cuyahoga Falls, OH (US)

Correspondence Address: CHRISTOPHER H. HUNTER, PARKER-HANFIN CORPORATION, 6035 PARKLAND BOULEVARD, CLEVELAND, OH, 44124-4141, US

(21) Appl. No.: 12/637,292

(22) Filed: Dec. 14, 2009

Related U.S. Application Data
(60) Provisional application No. 61/168,955, filed on Apr. 14, 2009.

(51) Int. Cl. F16D 65/16

(52) U.S. Cl. 188/156

(57) ABSTRACT

A brake including i) a caliper; ii) brake linings associated with the caliper; iii) at least one spring that forces the brake linings toward each other; and iv) an electromechanical actuator capable of forcing the brake linings away from each other against the spring force when actuated in a first direction and also capable of forcing the brake linings toward each other in combination with the spring force when actuated in a second direction opposite the first direction.

### CROSS-REFERENCE TO RELATED CASES

The present application claims the benefit of the filing date of U.S. Provisional Application Ser. No. 61/168,955; filed Apr. 14, 2009, the disclosure of which is expressly incorporated herein by reference.

### TECHNICAL FIELD

The present invention relates to a braking system for a wind turbine, and in particular, to a brake having a “fail safe” spring mechanism and an electromechanical actuator providing an assist to the spring mechanism during dynamic braking.

### BACKGROUND

The primary braking system for most modern wind turbines is the aerodynamic braking system, which essentially consists in turning the rotor blades about 90 degrees along their longitudinal axis (in the case of a pitch controlled turbine or an active stall controlled turbine), or in turning the rotor blade tips 90 degrees (in the case of a stall controlled turbine).

A mechanical brake is used as a backup system for the aerodynamic braking system, and as a parking brake, once the turbine is stopped in the case of a stall controlled turbine. The mechanical brakes typically comprise two hydraulically actuated calipers that engage a disk on the shaft that connects gearbox and generator. In case an emergency, braking of the wind turbine is needed, the mechanical brake is activated simultaneously to the aerodynamic brakes.

More recently, electromechanical brakes have been used in place of the hydraulic brakes. In electromechanical brakes, an electric device generates the necessary energy once braking action is required. Some of the advantages of electromechanical brakes compared to hydraulic systems is that they are easy to install, require minimal maintenance, and are cleaner to operate in that no hydraulic oil is required.

### SUMMARY

At least one embodiment of the invention provides a brake comprising a caliper; brake linings associated with the caliper; at least one spring that forces the brake linings toward each other; an electromechanical actuator capable of forcing the brake linings away from each other against the spring force when actuated in a first direction and also capable of forcing the brake linings toward each other in combination with the spring force when actuated in a second direction opposite the first direction.

### BRIEF DESCRIPTION OF THE DRAWINGS

Embodiments of this invention will now be described in further detail with reference to the accompanying drawing, in which:

FIG. 1 is a perspective view of the electromechanical actuator brake for wind turbines of the present invention;

FIG. 2 is a sectional perspective view of the electromechanical actuator brake showing the interior of the actuator in FIG. 1; and

FIG. 3 is a graph showing the clamping force of a prior art hydraulic brake and the clamping force components of a brake in accordance with an embodiment of the present invention.

### DETAILED DESCRIPTION OF THE DRAWINGS

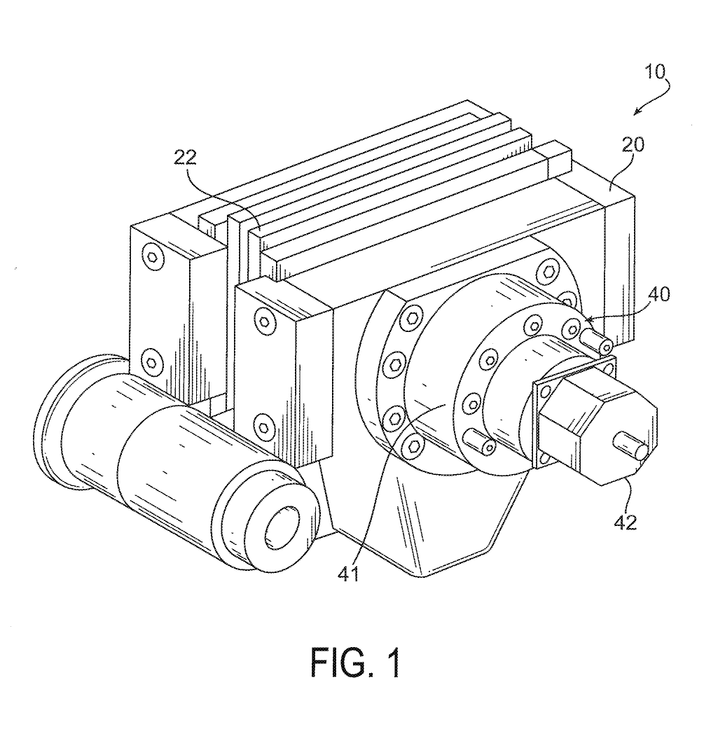

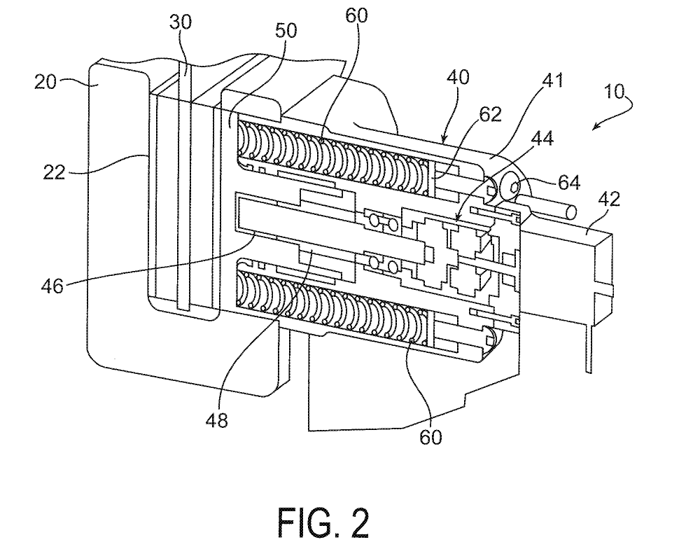

Referring now to FIGS. 1 and 2, an embodiment of the electromechanical actuator brake 10 for wind turbines is shown in various views. The brake 10 comprises a brake caliper 20 having brake linings 22 that engage/disengage a rotating disc 30 and an electromechanical actuator 40 attached to the caliper 20. The electromechanical actuator 40 comprises a motor 42 coupled to a gear system 44, the gear system 44 directly coupled to a ball screw 46. Rotation of the ball screw 46 causes a ball screw nut 48 to move a pusher plate 50. The actuator 40 also includes a housing 41 which protects the actuator components from the environment.

The pusher plate 50 is acted upon by at least one compression spring 60. The compression spring 60 causes the pusher plate 50 to move toward the disc 30 to engage the brake 10 by creating a clamping load on the linings 22 and the disc 30.

During operation, the brake 10 is disengaged by the electromechanical actuator 40 which retracts the pusher plate 50 away from the disc 30 and compresses the spring 60. In a stopping situation, the actuator 40 can move the pusher plate 50 toward the disc 30 to allow the compression spring 60 to extend and provide a clamping force to stop or slow the disc 30. If additional clamping force is required, the actuator 40 can move the pusher plate 50 to assist the spring 60. Accordingly, the brake 10 provides a hybrid passive and active brake system by providing the “Fail safe” of the spring 60 and using the electromechanical force of the actuator 40 to increase the clamping force beyond the spring force. In the same manner, the clamping force can be controlled by incrementing the motor and using an encoder or strain gauge to provide a closed loop control of the braking. Use of an encoder also allows the brake 10 to compensate for the decrease in spring force caused by lining wear and provides the actual wear and lining thickness.

During an electrical power failure, the springs will clamp on the disc at 100% spring force. Since the motor is not energized, the brake system will not be at full torque rating. This reduction in clamping force is beneficial and extends the life of the wind turbine gearbox. The fail safe spring clamping load of the brake will be sufficient for parking brake torque requirements. Parking brake torque requirements are less than dynamic braking torque requirements.

In one embodiment of the invention as best shown in FIG. 2, the spring force provided by the compression spring(s) 60 is adjustable. The end of the spring 60 is held in place by a disc 62 in the spring cylinder that is held in place by a set screw 64. The spring force can be reduced by adding washers underneath one or more of the set screw heads which will also provide a visual indication for spring force setting by means of washers. In the embodiment shown, the spring force can be easily modified down to 50% of nominal torque. During an electrical power failure, the springs will clamp on the disc at 100% spring force. Since the motor is not energized, the brake system will not be at full torque rating. This reduction in clamping force is beneficial and extends the life of the wind turbine gearbox. The springs are field adjustable in that the springs can be replaced and/or the length of compression of the spring modified to correspond to the wind turbine torque requirement.

The brake 10 can use the same gearbox mounting location, brake bracket, floating brake/rod system as the current existing hydraulic brakes making the brake 10 retrofittable into existing wind turbines.

In the embodiment shown, the ball screw 46 is a high efficiency ball screw, which allows the use of inexpensive dowel pins to be used to prevent rotation of the pusher plate 50 instead of expensive splines. In the embodiment shown, the gear system is a two-stage 25:1 planetary gear which, along with the high efficiency ball screw, allows for smaller motor torque requirement. The smaller motor shown in the embodiment utilizes low amperage and voltage which allows for an uninterruptable power supple to be used.

Although not shown, the brake can utilize two latches or bolts to release the brake. It is also contemplated that the actuator can be used for the yaw brake in addition to application as the high speed shaft brake. This is beneficial for economy of scale, inventory and maintenance.

The brake 10 replaces existing hydraulic brakes used in the Wind Turbine Market. The clamping load of the brake is produced by a compact gearbox drive train and springs. The compact gearbox drive train is a co-axial design and includes a motor, planetary gears and ball screw. It provides the primary source for controlling the brake clamping load. The springs supplement the braking clamp load and also provide fail safe operation during power failure. The supplemental clamping force from the springs during braking allows the electromechanical actuator to be minimized with a smaller motor, gearbox and ball screw. The smaller components minimizes the physical size of the brake system and allows the co-axial design of the components which is more cost efficient.

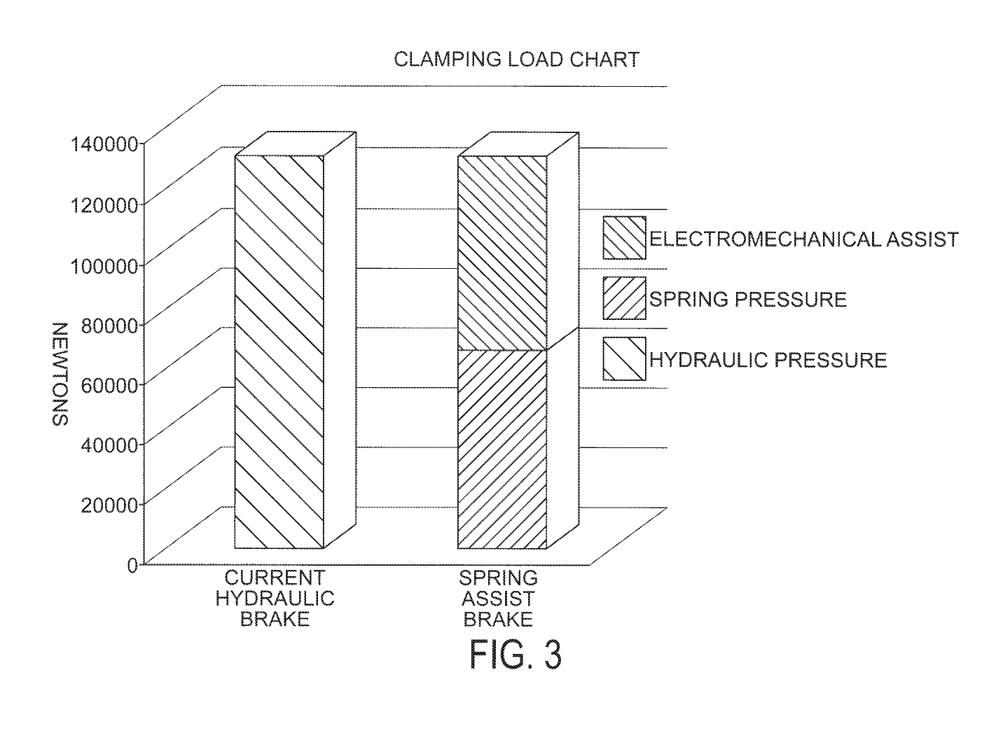

Referring now to FIG. 3, the amount of clamping force created from the brake will be controlled with the motor. The motor torque is directly proportional to the clamping load of the brake. The motor torque can decrease the spring force by compressing the springs via pusher plate or the motor can add to spring clamping force by driving the pusher plate into the friction material/rotor. The force from the combination of the springs and the motor torque will permit a smaller physically brake system and a compact drive train. The motor and drive system can be designed with a lower torque rating.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention. Accordingly, the scope and content of the present invention are to be defined only by the terms of the appended claims.

What is claimed is:

1. A brake comprising:
a caliper;
brake linings associated with the caliper;
at least one spring that forces the brake linings toward each other;
an electromechanical actuator capable of forcing the brake linings away from each other against the spring force when actuated in a first direction and also capable of forcing the brake linings toward each other in combination with the spring force when actuated in a second direction opposite the first direction.

2. The brake of claim 1, wherein the force provided by the spring is adjustable.

3. The brake of claim 1, wherein the electromechanical actuator comprises a stepper motor.

4. The brake of claim 1, wherein the electromechanical actuator comprises a gear system.

5. The brake of claim 1, wherein the electromechanical actuator comprises a ball screw and nut.
